(19) United States
(12) Patent Application Publication
(10) Pub. No.: US 2024/0214446 A1
(43) Pub. Date: Jun. 27, 2024

(54) FILE TRANSFER APPARATUS AND FILE TRANSFER METHOD

(71) Applicant: Canon Kabushiki Kaisha, Tokyo (JP)

(72) Inventor: DAIKI TSUBOTANI, Tokyo (JP)

(21) Appl. No.: 18/536,339

(22) Filed: Dec. 12, 2023

(30) Foreign Application Priority Data
Dec. 21, 2022 (JP) 2022-204639

(51) Int. Cl. H04L 67/06; G06F 16/16

(52) U.S. Cl. CPC H04L 67/06; G06F 16/164

(57) ABSTRACT

A file transfer apparatus is disclosed. The apparatus determines whether or not a first file whose base name is same as a base name of any file that in a transfer destination exists in a plurality of files to be transferred each of which has a file name including a base name and an extension. In a case where it is determined that the first file(s) exist in the plurality of files to be transferred, the apparatus collectively changes the base name of the first file(s), and transfers the plurality of files to be transferred to the transfer destination in a state in which no first file exists in the plurality of files to be transferred.

### BACKGROUND OF THE INVENTION

### Field of the Invention

The present invention relates to a file transfer apparatus such as a digital camera, for example, and a file transfer method executed by a file transfer apparatus.

### Description of the Related Art

Japanese Patent Laid-Open No. 2006-11749 describes an information processing apparatus including a function for automatically changing a base name in a case where a file with the same file name as a file present in a transfer destination exists in a plurality of data files (hereinafter, referred to simply as files) to be transferred to an external apparatus. Note that in the present specification, a file name includes a base name, a delimiter (period), and an extension.

In Japanese Patent Laid-Open No. 2006-11749, the base name of all files to be transferred or the files with duplicate file names is changed. In the case of the former, the base name is changed unnecessarily for files without duplicate file names. In the case of the latter, of the files with the same base name with a different extension, some may have their base name changed and some may not. In this case, a plurality of related files become unable to be identified on the basis of the base name.

### SUMMARY OF THE INVENTION

The present invention has been made in consideration of the aforementioned problems with known techniques, and an aspect of the present invention provides a file transfer apparatus and a file transfer method that can appropriately transfer a plurality of files including files with the same file name as a file that exists in the transfer destination.

According to an aspect of the present invention, there is provided a file transfer apparatus, comprising: one or more processors that execute a program stored in a memory and thereby function as: a determination unit configured to determine whether or not a first file whose base name is same as a base name of any file that in a transfer destination exists in a plurality of files to be transferred each of which has a file name including a base name and an extension, a rename unit configured to, in a case where it is determined that the first file(s) exist in the plurality of files to be transferred, collectively change the base name of the first file(s), and a transfer unit configured to transfer the plurality of files to be transferred to the transfer destination in a state in which no first file exists in the plurality of files to be transferred.

According to another aspect of the present invention, there is provided a file transfer method executed by a file transfer apparatus, comprising: determining whether or not a first file whose base name is same as a base name of any file that in a transfer destination exists in a plurality of files to be transferred each of which has a file name including a base name and an extension, in a case where it is determined that the first file(s) exist in the plurality of files to be transferred, collectively changing the base name of the first file(s), and transferring the plurality of files to be transferred to the transfer destination in a state in which no first file exists in the plurality of files to be transferred.

According to a further aspect of the present invention, there is provided a non-transitory computer-readable medium that stores a program which, when executed by a computer, causes the computer to function as a file transfer apparatus comprising: a determination unit configured to determine whether or not a first file whose base name is same as a base name of any file that in a transfer destination exists in a plurality of files to be transferred each of which has a file name including a base name and an extension, a rename unit configured to, in a case where it is determined that the first file(s) exist in the plurality of files to be transferred, collectively change the base name of the first file(s), and a transfer unit configured to transfer the plurality of files to be transferred to the transfer destination in a state in which no first file exists in the plurality of files to be transferred.

Further features of the present invention will become apparent from the following description of exemplary embodiments (with reference to the attached drawings).

### BRIEF DESCRIPTION OF THE DRAWINGS

FIGS. 1A to 1C are diagrams relating to configuration examples of a digital camera representing an example of a file transfer apparatus according to an embodiment.

FIGS. 2A to 2C are diagrams illustrating examples of configurations for storing files in a manner compliant with the DCF.

FIG. 3 is a flowchart relating to an example of file transfer processing according to an embodiment.

FIGS. 4A to 4E are diagrams illustrating examples of display screens according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that in the embodiments described below, the present invention is implemented as a digital camera. However, an image capture function is not necessary in the present invention, and the present invention can be implemented as any electronic device that can transfer data to an external apparatus. Examples of such an electronic apparatus include video cameras, computer devices (personal computers, tablet computers, media players, PDAs, and the like), mobile phones, smartphones, game consoles, and the like. These are examples, and the present invention can be implemented as other electronic devices.

### Internal Configuration of Digital Camera 100

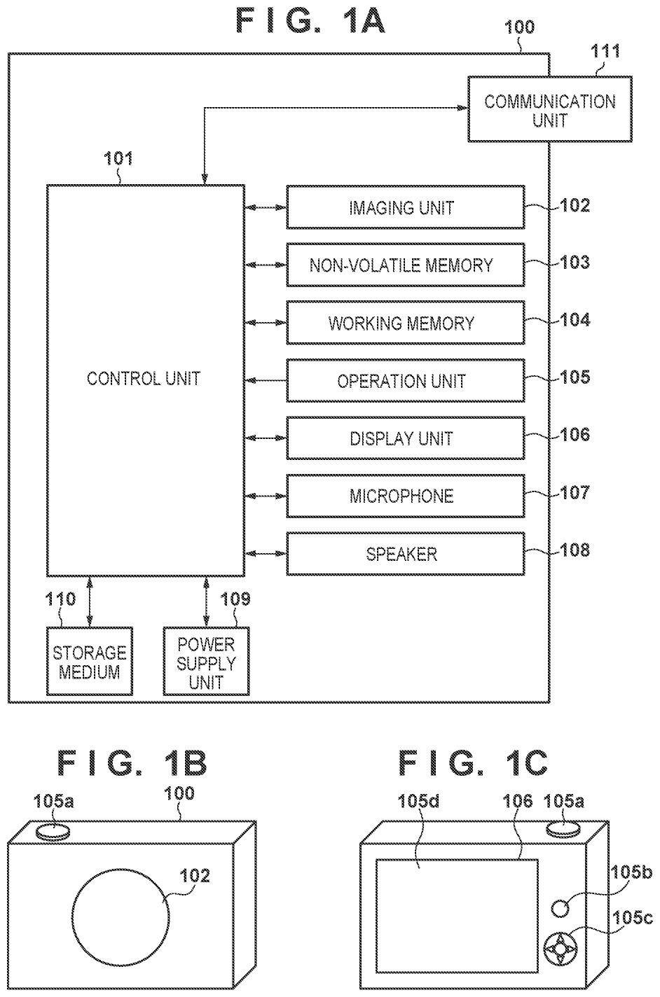

FIG. 1A is a block diagram illustrating a functional configuration example of a digital camera 100 representing a file transfer apparatus according to the present embodiment. FIGS. 1B and 1C are perspective views illustrating examples of the external appearance of the digital camera 100.

A control unit 101 is one or more processors (CPU, MPU, microprocessor, or the like) that can execute programs, for example. The control unit 101 loads a program stored in a non-volatile memory 103 into a working memory 104 and executes the program to control the operation of the units of the digital camera 100 and implement the function of the digital camera 100. In a case where the control unit 101 includes a plurality of processors, the plurality of processors share the processing load.

The non-volatile memory 103 is electrically rewritable and stores programs executable by the control unit 101, various types of setting values for the digital camera 100, GUI data, and the like.

The working memory 104 is RAM that loads programs executed by the control unit 101 and is used as a buffer for intermediate data of image processing by the control unit 101, captured still image data and moving image data, and the like. The control unit 101 uses the working memory 104 as video memory for a display unit 106.

An imaging unit 102 includes an optical system, a drive circuit therefor, and an image sensor. The optical system includes a plurality of lenses including a movable lens, an aperture, a drive circuit for the movable lens and the aperture, and the like. The movable lens is a focus lens, a lens for image stabilization, or the like, for example.

The image sensor, for example, may be a known CCD or CMOS color image sensor including a primary color Bayer array color filter. The image sensor includes a pixel array including a plurality of pixels in a two-dimensional array and a peripheral circuit for reading signals from the pixels. Each pixel accumulates a charge corresponding to the amount of incident light via photoelectric conversion. By reading a signal including voltage corresponding to the amount of charge accumulated in the exposure period from each pixel, a pixel signal group (analog image signal) representing a subject image formed on an imaging surface by the optical system is obtained.

The control unit 101 applies various types of image processing to the analog image signals.

The image processing applied by the control unit 101 may include, for example, preprocessing, color interpolation processing, correction processing, detection processing, data modification processing, evaluation value calculation processing, special effects processing, and the like.

The preprocessing may include A/D conversion, signal amplification, reference level adjustment, defective pixel correction, and the like.

The color interpolation processing is processing for interpolating values of color components not included in the pieces of pixel data forming the image data that is executed in a case where a color filter is provided in the image sensor. Color interpolation processing may be referred to as demosaic processing.

Correction processing may include various processing including white balance adjustment, tone correction, correction (image restoration) of image degradation caused by an optical aberration in the optical system, correction of the effects of vignetting of the optical system, color correction, and the like.

The detection processing may include processing for detecting a feature area (for example, a face area or a human body area) or movement thereof, processing for recognizing a person, and the like.

The data modification processing may include processing including trimming regions (trimming), combining, scaling, encoding and decoding, header information generation (file generation), and the like. Generating image data for display and image data for recording may also be included in the data modification processing.

The evaluation value calculation processing may include processing including generating signals or evaluation values that are used in automatic focus detection (AF), generating evaluation values that are used in automatic exposure control (AE), and the like.

Special effects processing may include processing including adding a blur effect, changing color tone, relighting, and the like.

Note that these are examples of the processing that can be applied by the control unit 101, and are not intended to limit the processing applied by the control unit 101.

The control unit 101 stores a file storing the generated image data for recording in a storage medium 110, which is a memory card, for example, according to the Design rule for Camera File system (DCF) standard specified by Japan Electronic Industry Development Association (JEIDA).

An operation unit 105 is a generic term for an input device (buttons, switches, dials, and the like) that is provided for the user to input various instructions to the digital camera 100. Each of the input devices constituting the operation unit 105 has a name corresponding to the function assigned to it. For example, the operation unit 105 includes an operation mode selection dial, a release switch 105a, a playback button 105b, a video recording switch, a shooting mode selection dial, a menu button, a directional key 105c, an enter key, and the like. Note that the functions assigned to the same input device may be variable. Also, the input device may be software buttons or keys using a touch display. The operation unit 105 may also include an input device compatible with non-contact input methods such as voice input and eye input.

The operation mode selection dial sets the operation mode of the digital camera 100 to one of a still image capturing mode, a video capturing mode, and a playback mode, for example. The shooting mode selection dial sets the shooting mode to one of a plurality of shooting modes prepared in advance.

The release switch is a switch for recording a still image, and the control unit 101 recognizes a half-pressed state of the release switch as an image capture preparation instruction and a fully-pressed state of the release switch as an image capture start instruction. Also, the control unit 101 recognizes a press of the moving image recording switch during an image capture standby state as a moving image recording start instruction and a press of the moving image recording switch during the recording of a moving image as a recording stop instruction.

When an image capture preparation instruction for a still image is detected, the control unit 101 executes automatic focus detection (AF) and automatic exposure control (AE). When an image capture start instruction for a still image is detected, the control unit 101 drives the aperture of the imaging unit 102 according to the exposure conditions set in the automatic exposure control (AE) and exposes the image sensor to light. Then, the control unit 101 generates still image data for recording from the analog image signal read out from the imaging unit 102 and stores it in the storage medium 110.

The display unit 106 is a touch display including a touch panel 105d, for example, that displays various types of information relating to the digital camera 100, images, menu screens, and the like. Also, by moving image capture being continuously executed by the imaging unit 102 and the captured moving images being displayed on the display unit 106, the display unit 106 can be caused to function as an electronic viewfinder (EVF). The operation to cause the display unit 106 to function as an EVF is referred as live view display, and the moving image displayed by live view is referred to as a live view image.

A microphone 107 records the environmental sounds of the digital camera 100 and outputs an audio signal. The control unit 101 applies a predetermined processing such as A/D conversion to the audio signal input from the microphone 107 and generates audio data. The data of audio recorded in parallel with moving image capture is treated as a part of the moving image data. Also, the control unit 101 can record the audio data in association with still image data.

A speaker 108 outputs audio recorded by the microphone 107, audio of the moving image data played back, warning sounds, sound effects (a click sound output when the dial or the like is operated, a focus-informing sound, and the like), and the like. The data of warning sounds and sound effects are stored in the non-volatile memory 103.

A power supply unit 109 is a battery, for example. The supply of power from the power supply unit 109 to each unit is controlled by the control unit 101.

The storage medium 110 is a storage destination for image data obtained by image capture and is a memory card, for example.

A communication unit 111 is a wired and/or wireless communication interface. The control unit 101 can communicate with an external apparatus via the communication unit 111. The control unit 101 can transmit (transfer) image files to an external apparatus via the communication unit 111, for example. Note that the communication standard that the wired and/or wireless communication interface of the communication unit 111 is compliant with is not particularly limited. Examples of wired and/or wireless communication interfaces include but are not limited to USB, HDMI (registered trademark), wireless LAN, Bluetooth (registered trademark), and the like.

### DCF File Configuration

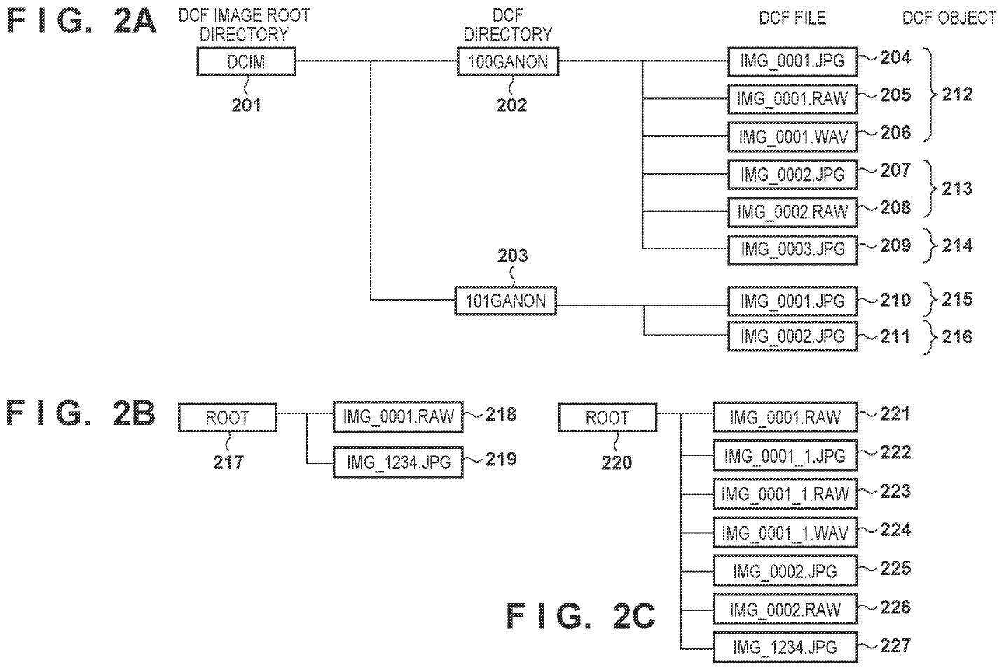

FIG. 2A is a diagram illustrating a file system of the storage medium 110 and a file storage example. As described above, the digital camera 100 stores a file in the storage medium 110 according to the DCF-compliant file system.

The DCF has a hierarchical directory structure, and the DCF image root directory (“DCIM”) is created directly below the root directory. One or more DCF directories are created below the DCF image root directory, and a file (DCF file) is stored in any of the DCF file directories. In FIG. 2A, two DCF directories 202 and 203 are created.

Each DCF directory includes a DCF directory number made of a non-duplicate three digit number from 100 to 999 and a directory name made of five free characters. Also, a DCF file stored below the DCF directory includes four free characters, a base name made of a four digit number (file number) from 0001 to 9999, a period as a delimiter, and a three character extension. Note that for the free characters, half-width capital English letters or numbers must be used, and for the number, half-width numbers must be used.

Note that in the DCF, the DCF file name is specified as the portion excluding the delimiter and the extension (the four free characters and the four character file number), however in the present specification, the DCF file name is referred to as the base name.

In the example in FIG. 2A, DCF files 204 to 209 are created in a DCF directory 202 (“100GANON”), and DCF files 210 and 211 are created in a DCF directory 203 (“101GANON”). The DCF files 204 to 211 are image files or audio files.

In the DCF directory, a file group with the same file number is referred to as a DCF object. Note that a DCF file for which another DCF file with the same file number does not exist may also form one DCF object. By providing related files with a same file number, the DCF object can be managed as a whole.

In the DCF, DCF objects are permitted to include different free characters. On the other hand, the digital camera 100 is configured such that DCF files that form the same DCF object are provided with same free characters and stored in the storage medium 110. Note that the method for determining which DCF object the DCF file to be stored forms may be a known method, and thus this will not be described in detail. Accordingly, in the present embodiment, a plurality of DCF files forming a DCF object include a same base name.

In the example in FIG. 2A, DCF objects 212 and 213 are stored in the DCF directory 202. Also, DCF objects 215 and 216 are stored in the DCF directory 203.

The DCF object 212 is formed by the three DCF files 204 to 206. The DCF files 204 to 206 include a same base name “IMG_0001” and different extensions, JPG, RAW, and WAV. The DCF files 204 and 205 with the JPG and RAW extension are related image files. Here in this example, they are image files generated in a JPEG format and RAW format simultaneous recording mode. Also, the DCF file 206 with the WAV extension is an audio file related to the DCF files 204 and 205.

The DCF object 213 is formed by the two DCF files 207 and 208. The DCF files 207 and 208 include a same base name “IMG_0002” and different extensions, JPG and RAW. Also, DCF objects 214 to 216 are each formed by the one DCF file 209 to 211.

### Setting the Type of Image File to be Transferred

In the digital camera 100, if the DCF object to be transferred includes a plurality of image files, the user can set which DCF files are to be transferred on the basis of the extension.

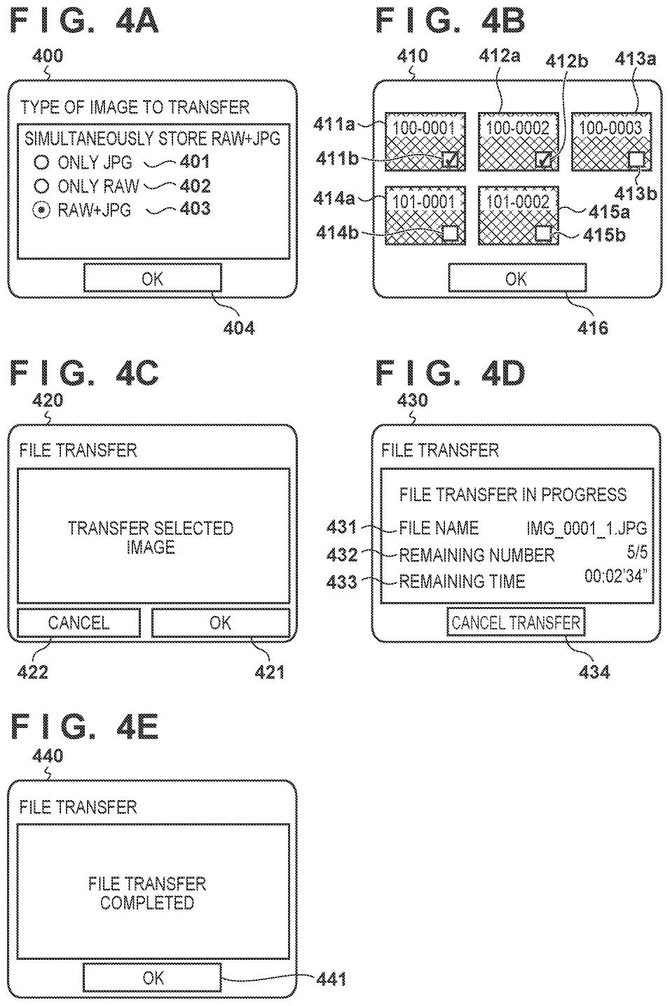

FIG. 4A is a diagram illustrating an example of a settings screen 400 for the type of image file to be transferred. The settings screen 400, for example, can be displayed on the display unit 106 and is operated via the menu button, the directional key 105c, and the enter key included on the operation unit 105. Note that the settings screen 400 may be displayed by the control unit 101 without a user operation and at any timing. Also here, settings set via the settings screen 400 are applied to all of the DCF objects to be transferred, but may be set per DCF object.

Here, with one instance of still image capturing by the digital camera 100, an image file with the RAW extension and/or an image file with the JPG extension can be recorded. Thus, in a case where the settings screen 400 is configured such that, in a case where the DCF object includes both an image file with the RAW extension and an image file with the JPG extension, the user can select the type of image file to be transferred.

Specifically, the settings screen 400 includes radio buttons 401 to 403 corresponding to three items, “only JPG”, “only RAW”, and “RAW and JPG”, and an OK button 404. The “only JPG” setting is for transferring the DCF file with the JPG extension and not transferring the DCF file with the RAW extension. The “only RAW” setting is for transferring the DCF file with the RAW extension and not transferring the DCF file with the JPG extension. The “RAW and JPG” setting is for transferring the DCF file with the RAW extension and the DCF file with the JPG extension.

For example, each time the directional key 105c is operated, the selected state of the radio buttons 401 to 403 is changed. The user can operate the directional key 105c to put the radio button corresponding to the type of image file they wish to be transferred into the selected state and then operate the select button to set the type of image file to be transferred. Note that the radio buttons may be selected and the OK button 404 operated via a touch operation.

When an operation of the select button or a touch operation of the OK button 404 is detected, the control unit 101 stores the setting corresponding to the radio button in a selected state in the non-volatile memory 103. Note that the DCF object may include image files of three or more types. Also, the plurality of types of DCF files that can be included in the DCF object is not limited to image files. For example, the DCF object may include a plurality of audio files of different extensions. The settings screen 400 may be changed depending on the type of DCF file that can be included in the DCF object in the digital camera 100.

### File Transfer

Next, the operations of the control unit 101 when transferring a file stored in the storage medium 110 to an external apparatus will be described.

Here, when the operation mode of the digital camera 100 is the playback mode, the DCF objects stored in the storage medium 110 are displayed in a list in a selectable manner, and the DCF files included in the DCF object selected by the user are transferred to an external apparatus.

When the operation mode being switched to the playback mode via the operation mode selection dial included in the operation unit 105 is detected, for example, the control unit 101 switches the operation mode of the digital camera 100 to the playback mode. Then, the control unit 101 displays, on the display unit 106, a selection screen for the user to select whether to execute playback or transfer.

When transfer is selected from the selection screen, the control unit 101 displays, on the display unit 106, a screen with the DCF objects stored in the storage medium 110 displayed in a list in a selectable manner. Here, the control unit 101 displays an image index display screen 410 as illustrated in FIG. 4B.

The image index display screen 410 displays thumbnails of the image files included in the DCF object stored in the storage medium 110 in a list in a selectable manner. Note that DCF objects not including any image files may be excluded from the displayed list or a predetermined image may be displayed.

In the image index display screen 410, scaled down images (thumbnails) 411a to 415a corresponding to the DCF objects are displayed. In a case where one DCF object includes a plurality of image files, a thumbnail corresponding to one of the image files is displayed. Also, checkboxes 411b to 415b, which are indicators indicating whether or not the DCF objects are selected, are displayed.

The control unit 101, via operation of the directional key 105c, can move the focus (for example, a frame-like image) to the thumbnails 411a to 415a and an OK button 416. Then, if the focus is on a thumbnail when the select button is operated, the control unit 101 changes the state of the checkbox corresponding to the thumbnail. Alternatively, the control unit 101 changes the state of each corresponding checkbox each time a thumbnail is touched.

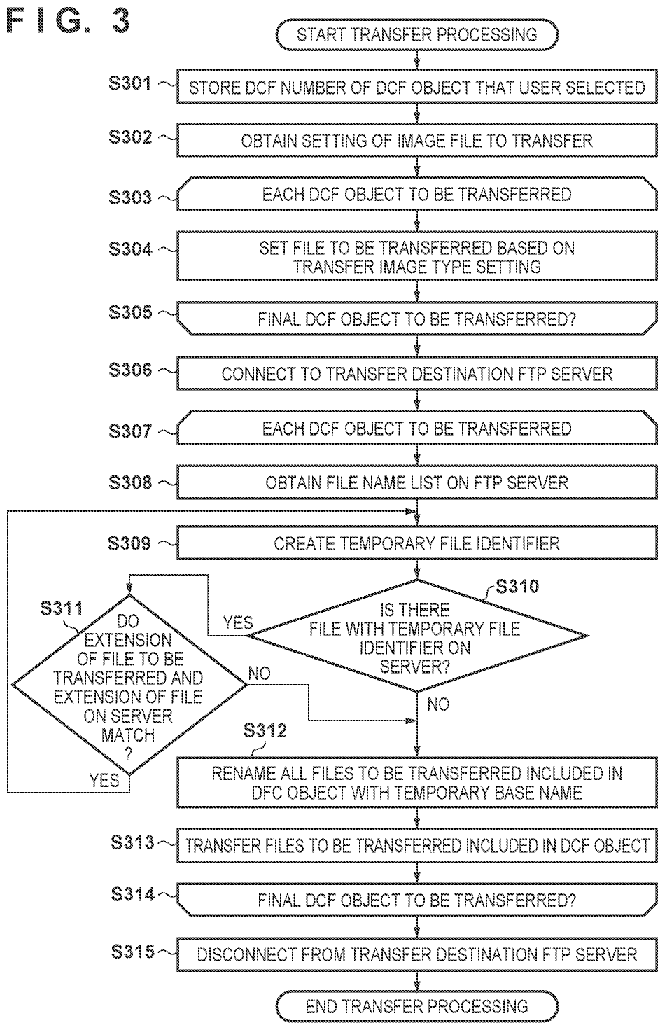

When the select button is operated with the focus on the OK button 404 or when the OK button 416 is touched, the control unit 101 recognizes the DCF object corresponding to the checked checkbox as the object to be transferred. Then, the operations in the flowchart in FIG. 3 are started. In the example described below, the DCF objects 212 and 213 are objects to be transferred. In this manner, the control unit 101 manages the objects to be transferred on a DCF object basis.

Note that when an operation of the OK button 404 is detected, it may be confirmed with the user whether or not to execute file transfer. In this case, the control unit 101 can display, on the display unit 106, a confirmation screen 420 such as that illustrated in FIG. 4C, for example. The confirmation screen 420 includes an OK button 421 and a cancel button 422. In a case where an operation of the OK button 421 is detected, the control unit 101 executes step S301. In a case where an operation of the cancel button 422 is detected, the control unit 101 returns the display to the image index display screen 410.

In step S301, the control unit 101 stores identification information of the DCF object to be transferred in the working memory 104. Here, a DCF number is used as the identification information of the DCF object. A DCF number corresponds to characters generated from the DCF directory number and the DCF file number. Here, characters obtained by connecting the DCF directory number and the DCF file number with a hyphen correspond to the DCF number. For example, the DCF number for the DCF object 212 illustrated in FIG. 2A is 100-0001. Note that when comparing the size of DCF numbers, the characters are treated as a seven digit numerical value without the hyphen.

The control unit 101 manages the DCF objects to be transferred in ascending order for DCF numbers. Also, the DCF object with the smallest DCF number is the first DCF object, and the DCF object with the largest DCF number is the final DCF object.

Accordingly, in step S301, the control unit 101 stores the DCF number “100-0001” of the DCF object 212 and the DCF number “100-0002” of the DCF object 213 in the working memory 104. Also, the first DCF object is the DCF object 212, and the final DCF object is the DCF object 213.

In step S302, the control unit 101 reads out the type of the image file to be transferred set via the settings screen 400 from the non-volatile memory 103. Here, it is set to “RAW and JPG”.

In steps S303 to S305, the control unit 101 sets the DCF file to be transferred for each DCF object to be transferred.

First, in step S303, the control unit 101 obtains the identification information of the DCF object to be transferred stored in the working memory 104. Each time step S303 is executed, the control unit 101 obtains this in order from the identification information of the first DCF object.

In step S304, the control unit 101 sets the DCF file to be transferred from the DCF object corresponding to the identification information obtained in step S303. In a case where the DCF object includes both an image file with the RAW extension and an image file with the JPG extension, the image file to be transferred is set according to the setting obtained in step S302. Also, if the DCF file is not an image file, the control unit 101 sets all of them to be transferred.

In step S305, the control unit 101 determines whether or not the processing of step S304 has been executed for all DCF objects up to the final DCF object. If the processing of step S304 has been executed for all DCF objects up to the final DCF object, the control unit 101 executes step S306, otherwise, the control unit 101 executes step S303.

The processing of steps S303 to S305 in a case where the DCF objects 212 and 213 are to be transferred will now be described in detail.

In step S303, the control unit 101 identifies the DCF object 212 from the DCF number “100-0001”.

In step S304, the control unit 101 confirms the type of the image file included in the DCF object 212. Since the DCF object 212 includes both an image file with the RAW extension and an image file with the JPG extension, the control unit 101 sets both image files as DCF files to be transferred according to the settings. Also, DCF files other than image files included in the DCF object 212 are also set as DCF files to be transferred. As a result, the control unit 101 sets the “IMG_0001.JPG” 204, “IMG_0001.RAW” 205, and “IMG_0001.WAV” 206 of the DCF object 212 as DCF files to be transferred.

In step S305, since the DCF object 212 most recently set as a DCF file to be transferred in step S304 is not the final DCF object, the control unit 101 executes step S303.

When step S303 is executed for the second time, the control unit 101 identifies the DCF object 213 from the DCF number “100-0002”. In step S304, since the DCF object 213 includes both an image file with the RAW extension and an image file with the JPG extension, the control unit 101 sets both image files as DCF files to be transferred according to the settings. Since the DCF object 213 includes only image files, the control unit 101 sets the “IMG_0002.JPG” 207 and the “IMG_0002.RAW” 208 of the DCF object 213 as DCF files to be transferred.

In step S305, since the DCF object 213 most recently set as a DCF file to be transferred in step S304 is the final DCF object, the control unit 101 executes step S306.

In step S306, the control unit 101 executes processing to connect with an external apparatus via the communication unit 111 on the basis of network connection settings set in advance and stored in the non-volatile memory 103. Here, the external apparatus is an FTP server, and the connection processing is login processing. The information required for login is stored in the non-volatile memory 103 in advance.

In steps S307 to S314, the control unit 101 transfers the DCF files to be transferred set in step S304 for each DCF object to be transferred in order to the external apparatus. Also, the DCF files are renamed before transfer as necessary.

In step S307, as in step S303, the control unit 101 identifies the DCF object to be transferred in order from the first DCF object.

In step S308, the control unit 101 obtains the file name list that exists in the destination directory of the FTP server. In the present embodiment, for the sake of convenience, as illustrated in FIG. 2B, the destination is set to root directory “ROOT” 217 of the FTP server. Also, two image files “IMG_0001.RAW” 218 and “IMG_1234.JPG” 219 exist. Thus, in step S308, the control unit 101 obtains a file name list including “IMG_0001.RAW” and “IMG_1234.JPG” from the FTP server.

In step S309, the control unit 101 creates a temporary base name. Note that when step S309 is executed for the first time for the same DCF object, the control unit 101 uses the base name of the DCF file unchanged as the temporary base name, without creating a temporary base name. Alternatively, the control unit 101 may skip step S309.

When step S309 is executed for the second time or more for the same DCF object, the control unit 101 creates a temporary base name. The method for creating a temporary base name is not particularly limited, and in this example, specific characters are added to a specific position of the original base name. Here, for example, “_n” is added to the end of the original base name, but other characters may be added or the characters may be added at a different position of the original base name (for example, at the front). Alternatively, instead of adding characters or in addition to, the characters of the base name may be changed to create a temporary base name. Here, n is an integer of 1 or more, and the initial value is 1. In a case where step S309 is executed for the third time or more for the same DCF object, n is increased by 1. Thus, the temporary base name generated for the same DCF object becomes original base name_1, original base name_2, and so on each time step S309 is executed.

In steps S310 and S311, the control unit 101 determines whether or not the DCF file needs to be renamed.

First, in step S310, control unit 101 uses the file name list obtained in step S308 to determine whether or not a file with the same base name as the temporary base name set in step S309 most recently executed exists in the destination.

If the control unit 101 determines that a file with the same base name as the temporary base name exists in the destination, the control unit 101 stores, in the working memory 104, all of the file names of the files with the same base name as the temporary base name that exist in the transfer destination and executes step S311.

On the other hand, if the control unit 101 determines that a file with the same base name as the temporary base name does not exist in the transfer destination, the control unit 101 executes step S312.

Here, the image file 218 with the same base name as the base name “IMG_0001” of the DCF file included in the DCF object 212 being processed exists in the transfer destination. Thus, the control unit 101 stores the file name “IMG_0001.RAW” of the image file 218 in the working memory 104 and executes step S311.

In step S311, the control unit 101 compares the extension of the file name stored in the working memory 104 in step S310 and the extension of the DCF file to be transferred included in the DCF object being processed and determines whether or not a match exists. If the control unit 101 determines that file names with matching extensions exist, the control unit 101 executes step S309 and creates a new temporary base name. On the other hand, if the control unit 101 determines that file names with matching extensions do not exist, the control unit 101 executes step S312.

The extensions of the DCF files to be transferred of the DCF object 212 being processed are “JPG”, “RAW”, and “WAV”, and the extension of the file name stored in the working memory 104 is “RAW”. Thus, the control unit 101 determines that file names with matching extensions exist and executes step S309.

Note that in a case where, in step S310, it is determined that a file with the same base name as the temporary base name exists in the transfer destination, the control unit 101 may execute step S309 without executing step S311. This can avoid a file in the transfer destination normally not included in the DCF object from being taken as being included in the DCF object.

When step S309 is executed for the second time or more for the DCF object 212, the control unit 101 creates the temporary base name “IMG_0001_1”.

Then, in step S310, the control unit 101 executes the determination described above for the temporary base name “IMG_0001_1”. Since a file with the same base name as the current temporary base name does not exist in the transfer destination, the control unit 101 executes step S312.

In step S312, the control unit 101 substitutes the base name of the DCF files to be transferred included in the DCF object being processed for the temporary base name to collectively rename the DCF files to be transferred. Note that in a case where the temporary base name is the original base name (step S309 has only been executed once for the DCF object being processed), renaming is not required, and step S312 may be skipped.

Specifically, the control unit 101 substitutes the base name “IMG_0001” of the DCF files to be transferred included in the DCF object 212 for the temporary base name “IMG_0001_1”. In this manner, the DCF files to be transferred are collectively renamed “IMG_0001_1.JPG” 204, “IMG_0001_1.RAW” 205, and “IMG_0001_1.WAV”.

In a case where a file with a file name (or base name) that matches that of a DCF file to be transferred exists in the transfer destination, the base name of the DCF file to be transferred is changed by the control unit 101 such that file and base names are not duplicated in the transfer destination. In this manner, only the DCF files that need to be renamed can be renamed while maintaining the association between files.

This results in less processing load compared to a configuration in which, in a case where even one file with a file name that is the same as a file that exists in the transfer destination is included in a file to be transferred, the files to be transferred are all renamed. Also, this avoids the loss of association between files that may occur when only the files with a file name that is the same as that of a file that exists in the transfer destination are renamed.

In step S313, the control unit 101 sequentially transfers the DCF files to be transferred included in the DCF object being processed. Note that, during file transfer, the control unit 101 may display, on the display unit 106, a transfer-in-progress screen 430 such as that illustrated in FIG. 4D, for example, to notify a user to the state of progress of the file transfer.

The transfer-in-progress screen 430 includes a file name 431 of the file being transferred, a remaining number 432 to be transferred (file number), a remaining time 433 until completion of transfer, and a cancel transfer button 434 for issuing an instruction to interrupt transfer. Note that the remaining number 423 and the remaining time 433 displayed on the transfer-in-progress screen 430 may be values per DCF object or may be a value for all of the DCF objects to be transferred.

In step S314, the control unit 101 determines whether or not the DCF object being processed is the final DCF object. If it is the final DCF object, step S315 is executed. If it is not the final DCF object, step S307 is executed. Here, the DCF object 212 being processed is not the final DCF object, and thus the control unit 101 executes step S307.

The processing of steps S307 to S314 for the second time will now be described.

In step S307, the control unit 101 identifies the next DCF object 213 to process from the DCF number “100-0002”. As has been executed for the DCF object 212, the control unit 101 executes the processing of steps S308 to S310 on the DCF object 213. In step S309, the control unit 101 sets the original base name “IMG_0002” to a temporary base name. Also, in step S310, the control unit 101 determines that a file with the same base name as the temporary base name “IMG_0002” does not exist in the transfer destination and executes step S312.

In step S312, since the current temporary base name “IMG_0002” is the original base name, the control unit 101 executes step S313 without renaming the DCF file to be transferred.

In step S313, the control unit 101 transfers the DCF files to be transferred as “IMG_0002.JPG” 207 and “IMG_0002.RAW” 208 without renaming them and executes step S314.

In step S314, the control unit 101 determines that the DCF object 213 being processed is the final DCF object and thus executes step S315.

In step S315, the control unit 101 disconnects the connection with the FTP server via the communication unit 111. Also, after the connection is disconnected, the control unit 101 can display a transfer complete screen 440, as illustrated in FIG. 4E for example, on the display unit 106. The transfer complete screen 440 is a screen for notifying the user that the transfer processing for the DCF object selected by the user has ended and includes an OK button 441. When it is detected that the user has operated the OK button 441, the control unit 101 displays the image index display screen 410 illustrated in FIG. 4B on the display unit 106.

When the processing to transfer the DCF objects 212 and 213 to the destination directory illustrated in FIG. 2B is executed, the destination directory becomes like illustrated in FIG. 2C. The base name of the DCF files to be transferred included in the DCF object 212 have been renamed from “IMG_0001” to “IMG_0001_1” and stored. However, the relationship between the “IMG_0001_1.JPG” 221, “IMG_0001_1.RAW” 222, and “IMG_0001_1.WAV” 223 is maintained due to the same base name.

Also, the DCF files to be transferred included in the DCF object 213 are stored, without renaming, as “IMG_0002.JPG” 225 and “IMG_0002.RAW” 226.

Also, the FTP server only stores the DCF object with the file name specified by the digital camera 100, thus there is no need for additional special processing. This suppresses an increase in the processing load of the FTP server.

Note that in the embodiment described above, DCF files with the extensions “JPG”, “RAW”, and “WAV” are handled, but files with other extensions may also be used.

Also, a method for managing files using DCF is used as an example, but another file management method may be used.

Furthermore, a method other than FTP may be used for the image transfer method.

### Other Embodiments

In the embodiment described above, files are transferred using FTP, but another protocol may be used. Also, the type of file is not particularly limited. Furthermore, the file name naming convention is not limited to that of the DCF. Any naming convention can be used that can represent association between files using a file name.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-204639, filed Dec. 21, 2022, which is hereby incorporated by reference herein in its entirety.

What is claimed is:

1. A file transfer apparatus, comprising:
one or more processors that execute a program stored in a memory and thereby function as:
a determination unit configured to determine whether or not a first file whose base name is same as a base name of any file that in a transfer destination exists in a plurality of files to be transferred each of which has a file name including a base name and an extension,
a rename unit configured to, in a case where it is determined that the first file(s) exist in the plurality of files to be transferred, collectively change the base name of the first file(s), and
a transfer unit configured to transfer the plurality of files to be transferred to the transfer destination in a state in which no first file exists in the plurality of files to be transferred.

2. The file transfer apparatus according to claim 1, wherein
the rename unit substitutes an original base name for a temporary base name to rename the first file(s),
the determination unit further determines whether or not a file having a temporary base name to be used exists in the transfer destination, and
the rename unit changes the temporary base name to be used in a case where it is determined that a file having the temporary base name to be used exists in the transfer destination.

3. The file transfer apparatus according to claim 2, wherein
the rename unit modifies the original base name to create the temporary base name.

4. The file transfer apparatus according to claim 2, wherein
the rename unit adds specific characters at a specific position of the original base name to create the temporary base name.

5. The file transfer apparatus according to claim 1, wherein
in a case where it is determined that the first file exists in the plurality of files to be transferred, the determination unit further determines whether or not the file having the same base name as the first file also having the same extension as the first file,
the rename unit, in a case where it is determined that a second file whose base name and extension are same as any file in the transfer destination exists in the plurality of files to be transferred, collectively changes the base name of the first file(s) in the plurality of files to be transferred, and
the transfer unit transfers the plurality of files to be transferred to the transfer destination in a state in which no second file exists in the plurality of files to be transferred.

6. The file transfer apparatus according to claim 1, wherein
in the plurality of files to be transferred, a plurality of related files have a same base name.

7. The file transfer apparatus according to claim 1, wherein
the plurality of files to be transferred are DCF files having a base name compliant with a Design rule for Camera File system (DCF) standard.

8. The file transfer apparatus according to claim 7, wherein
the base name includes free characters and a DCF number, and
in the plurality of files to be transferred, a plurality of related files have same free characters and DCF number.

9. A file transfer method executed by a file transfer apparatus, comprising:
determining whether or not a first file whose base name is same as a base name of any file that in a transfer destination exists in a plurality of files to be transferred each of which has a file name including a base name and an extension,
in a case where it is determined that the first file(s) exist in the plurality of files to be transferred, collectively changing the base name of the first file(s), and
transferring the plurality of files to be transferred to the transfer destination in a state in which no first file exists in the plurality of files to be transferred.

10. A non-transitory computer-readable medium that stores a program which, when executed by a computer, causes the computer to function as a file transfer apparatus comprising:
a determination unit configured to determine whether or not a first file whose base name is same as a base name of any file that in a transfer destination exists in a plurality of files to be transferred each of which has a file name including a base name and an extension,
a rename unit configured to, in a case where it is determined that the first file(s) exist in the plurality of files to be transferred, collectively change the base name of the first file(s), and
a transfer unit configured to transfer the plurality of files to be transferred to the transfer destination in a state in which no first file exists in the plurality of files to be transferred.
